(19) United States
(12) Patent Application Publication
(10) Pub. No.: US 2019/0113125 A1
(43) Pub. Date: Apr. 18, 2019

(54) VEHICULAR POWER TRANSMITTING DEVICE

(71) Applicant: TOYOTA JIDOSHA KABUSHIKI KAISHA, Toyota-shi (JP)

(72) Inventors: Hiroshi OMI, Nisshin-shi (JP); Shingo MINEZAWA, Okazaki-shi (JP)

(73) Assignee: TOYOTA JIDOSHA KABUSHIKI KAISHA, Toyota-shi (JP)

(21) Appl. No.: 16/158,430

(22) Filed: Oct. 12, 2018

(30) Foreign Application Priority Data
Oct. 12, 2017 (JP) 2017-198890

(51) Int. Cl. F16H 57/027; F16H 57/029; F16H 57/04

(52) U.S. Cl. CPC F16H 57/027; F16H 57/029; F16H 57/0483; F16H 2057/02052; F16H 57/0409; F16H 57/0471; F16H 57/0493

(57) ABSTRACT

A vehicular power transmitting device comprising: a power transmitting shaft rotated by a drive power source; a housing accommodating the power transmitting shaft and rotatably supporting the power transmitting shaft through a tapered roller bearing; and a breather device including a breather plug, and a breather chamber for communication between an outside atmosphere outside the housing and an inside space within the housing, through the breather plug, the vehicular power transmitting device being characterized in that: the housing includes an oil passage for communication between the breather chamber and a small-diameter end side space partially defined by a small-diameter end face of a tapered roller of the tapered roller bearing.

This application claims priority from Japanese Patent Application No. 2017-198890 filed on Oct. 12, 2017, the disclosure of which is herein incorporated by reference in its entirety.

### FIELD OF THE INVENTION

The present invention relates to a technique for preventing or reducing leakage of a lubricant oil through a breather device provided in communication with a housing accommodating a vehicular power transmitting device.

### BACKGROUND OF THE INVENTION

The known vehicular power transmitting device is provided with a breather device having a breather plug and a breather chamber, so that an air within a housing of the vehicular power transmitting device is ejected into an outside atmosphere outside the housing, through the breather plug, to reduce a rise of the air pressure within the housing, for thereby preventing or reducing leakage of a lubricant oil from the housing. JP-2017-15156A discloses an example of such a vehicular power transmitting device including a differential gear device. This vehicular power transmitting device is provided with the breather device for reducing the rise of the air pressure within the housing to prevent or reduce the leakage of the lubricant oil from the housing. The lubricant oil within the housing is stirred up by gears and other members of the power transmitting device, and is likely to flow along inner surfaces of the housing and enter the breather chamber. To prevent or reduce the leakage of the lubricant oil from the breather chamber into the outside atmosphere through the breather plug, together with the air when the pressure of the air is raised, the housing is formed with an oil passage through which the lubricant oil flows from the breather chamber back into the housing, so that an amount of the lubricant oil staying within the breather chamber is reduced, whereby an amount of leakage of the lubricant oil into the outside atmosphere through the breather plug is reduced.

During running of a vehicle at a high speed wherein the air within the housing is rapidly expanded, however, mere provision of the oil passage for returning the lubricant oil from the breather chamber back into the housing may be insufficient. Thus, there has been a need of preventing or reducing the leakage of the lubricant oil from the housing through the breather chamber, by more effectively returning the lubricant oil from the breather chamber back into the housing.

### SUMMARY OF THE INVENTION

The present invention was made in view of the background art described above. It is therefore an object of the present invention to provide a vehicular power transmitting device provided with a breather device having a breather plug and a breather chamber for preventing or reducing leakage of a lubricant oil from a housing of the vehicular power transmitting device by ejecting an air from the housing into an outside atmosphere outside the housing, through the breather plug, when the pressure of the air within the housing is raised, which vehicular power transmitting device permits more effective prevention or reduction of the leakage of the lubricant oil from the housing.

The object indicated above is achieved according to the following modes of the present invention:

According to a first mode of the invention, there is provided a vehicular power transmitting device comprising: a power transmitting shaft rotated by a drive power source; a housing accommodating the power transmitting shaft and rotatably supporting the power transmitting shaft through a tapered roller bearing; and a breather device including a breather plug, and a breather chamber for communication between an outside atmosphere outside the housing and an inside space within the housing, through the breather plug, the vehicular power transmitting device being characterized in that the housing includes an oil passage for communication between the breather chamber and a small-diameter end side space partially defined by a small-diameter end face of a tapered roller of the tapered roller bearing.

According to a second mode of the invention, the housing is provided with an oil seal on the side of a small-diameter end of the tapered roller of the tapered roller bearing.

In the vehicular power transmitting device according to the first mode of the invention, the power transmitting shaft accommodated within the housing is rotated by the drive power source, and rotatably supported by the housing through the tapered roller bearing, and the breather chamber of the breather device including the breather plug provided on the housing is held in communication between the outside atmosphere and the inside space within the housing through the breather plug. The housing includes the oil passage for communication between the breather chamber and the small-diameter end side space which is partially defined by the small-diameter end face of the tapered roller of the tapered roller bearing. When the tapered roller bearing is rotated, there arises a difference between peripheral velocities of a large-diameter end portion and a small-diameter end portion of the tapered roller of the tapered roller bearing, due to a difference between outside diameters of the large-diameter and small-diameter end portions. This difference of the peripheral velocities generates a gradient of an air pressure such that the air pressure is lower in the small-diameter end side space than in a large-diameter end side space partially defined by a large-diameter end face of the tapered roller of the tapered roller bearing, so that a lubricant oil is sucked and discharged from the breather chamber back into the housing through the oil passage, whereby leakage of the lubricant oil from the breather chamber into the outside atmosphere can be effectively prevented or reduced.

In the vehicular power transmitting device according to the second mode of the invention wherein the housing is provided with the oil seal on the side of the small-diameter end of the tapered roller of the tapered roller bearing, the lubricant oil can be effectively supplied to the oil seal which is located at the position at which the oil seal would be otherwise difficult to be sufficiently lubricated. Accordingly, the oil seal can be lubricated with a high degree of efficiency, and deterioration of sealing property of the oil seal can be effectively reduced.

### BRIEF DESCRIPTION OF THE DRAWINGS

FIG. 1 is a schematic view showing an arrangement of a vehicular power transmitting device according to a first embodiment of this invention;

FIG. 2 is a cross sectional view for explaining a positional relationship between a breather plug and a tapered roller bearing of the vehicular power transmitting device shown in FIG. 1;

FIG. 3 is a cross sectional view showing in enlargement a portion of the vehicular power transmitting device shown in FIG. 2;

FIG. 4 is a cross sectional view for explaining a construction of the vehicular power transmitting device of FIG. 2, for transmitting a vehicle drive force from a power transmitting shaft to a propeller shaft;

FIG. 5 is a schematic view for explaining an air pressure gradient between two spaces on respective small-diameter and large-diameter end sides of a tapered roller of the tapered roller bearing shown in FIG. 2, which air pressure gradient is induced as a result of a rotary motion of the tapered roller bearing;

FIG. 6 is a view for explaining a position of an oil passage for communication between a breather chamber shown in FIG. 2, and the space on the small-diameter end side of the tapered roller of the tapered roller bearing, in a plane of interface of two members of a housing of the vehicular power transmitting device;

FIG. 7 is a view showing one of the two members of the housing, which is fixed to the other member shown in FIG. 6, in the plane of interface; and

FIG. 8 is a cross sectional view showing a rear wheel differential gear device of the vehicle of FIG. 1, which is constructed according to a second embodiment of this invention.

### DETAILED DESCRIPTION OF PREFERRED EMBODIMENTS

Preferred embodiments of the present invention will be described in detail by reference to the drawings. It is to be understood that the drawings showing the embodiments are simplified or transformed as needed, and do not necessarily accurately represent dimensions and shapes of various elements of the embodiments.

### First Embodiment

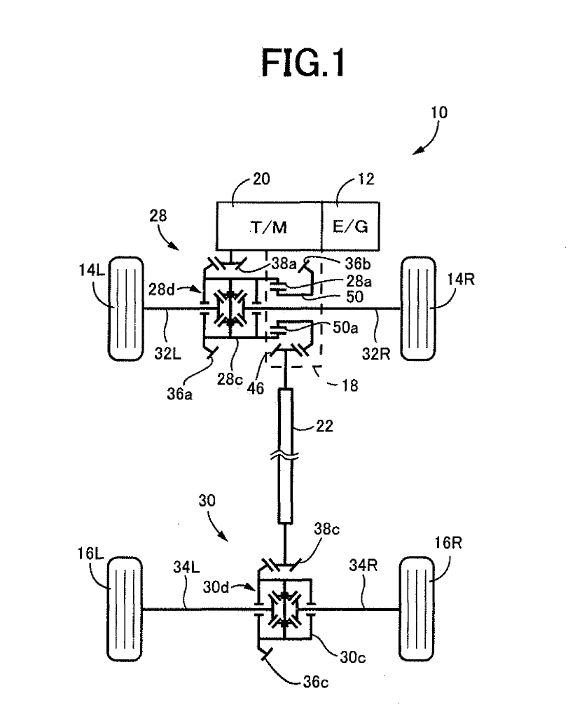

Reference is first made to FIG. 1, which is the schematic view showing an arrangement of a fourwheel-drive vehicle 10 constructed according to a first embodiment of this invention. As shown in FIG. 1, the four-wheel-drive vehicle 10 is of an FF (front-engine front-wheel drive) type having a power transmitting path through which a drive force of an engine 12 serving as a drive power source is transmitted to front wheels 14L and 14R (hereinafter referred to collectively as “front wheels 14” unless otherwise specified), and a power transmitting path through which the drive force of the engine 12 is transmitted to rear wheels 16L and 16R (hereinafter referred to collectively as “rear wheels 16” unless otherwise specified). The four-wheel-drive vehicle 10 includes an automatic transmission 20, a front wheel differential gear device 28, a transfer 18 serving as a power transmitting device, a propeller shaft 22, and a rear wheel differential gear device 30. It is noted that a fluid-operated power transmitting device in the form of a torque converter (not shown in FIG. 1) is interposed between the engine 12 and the automatic transmission 20.

The automatic transmission 20 is disposed in a power transmitting path between the engine 12 and the transfer 18. For example, the automatic transmission 20 is a step-variable transmission which includes a plurality of planetary gear sets, and a plurality of frictional coupling devices (such as clutches and brakes), and which has a plurality of operating positions (speed positions) to be established with respective combinations of engaged states of the frictional coupling devices. Since the automatic transmission 20 is known, detailed description of its construction and operation herein are not deemed necessary.

The front wheel differential gear device 28 includes a casing 28c and a known differential mechanism 28d of a bevel gear type through which an output rotary motion of the automatic transmission 20 is transmitted to left and right axles 32L and 32R (front wheel axle 32) connected to the respective two front wheels 14, so as to permit a difference between rotating speeds of the two front wheels 14. The front wheel differential gear device 28 includes a ring gear 36a which is connected to its casing 28c and which is held in meshing engagement with a drive pinion 38a that is an output rotary member of the automatic transmission 20. Thus, an output drive force of the automatic transmission 20 is transmitted to the ring gear 36a. The casing 28c of the front wheel differential gear device 28 is a cylindrical member a rotary motion of which is transmitted to the transfer 18 and which has inner gear teeth 28a formed on its inner circumferential surface. On the other hand, the transfer 18 includes a power transmitting shaft in the form of a sleeve 50 having outer gear teeth 50a formed on its outer circumferential surface. The casing 28c and the sleeve 50 are splined to each other, with the inner gear teeth 28a and the outer gear teeth 50a being held in engagement with each other. Since the front wheel differential gear device 28 is known, detailed description of its construction and operation herein are not deemed necessary.

The transfer 18 disposed adjacent to the front wheel differential gear device 28 transmits a drive force to the propeller shaft 22 through the outer gear teeth 50a of the sleeve 50, a ring gear 36b rotated together with the sleeve 50, and a driven pinion 46 held in meshing engagement with the ring gear 36b.

The drive force transmitted to the propeller shaft 22 is transmitted to the rear wheel differential gear device 30 through a drive pinion 38c. Like the front wheel differential gear device 28, the rear wheel differential gear device 30 includes a casing 30c and a known differential mechanism 30d of a bevel gear type through which a rotary motion of the propeller shaft 22 is transmitted to left and right axles 34L and 34R (rear wheel axle 34) connected to the respective two rear wheels 16, so as to permit a difference between rotating speeds of the two rear wheels 16.

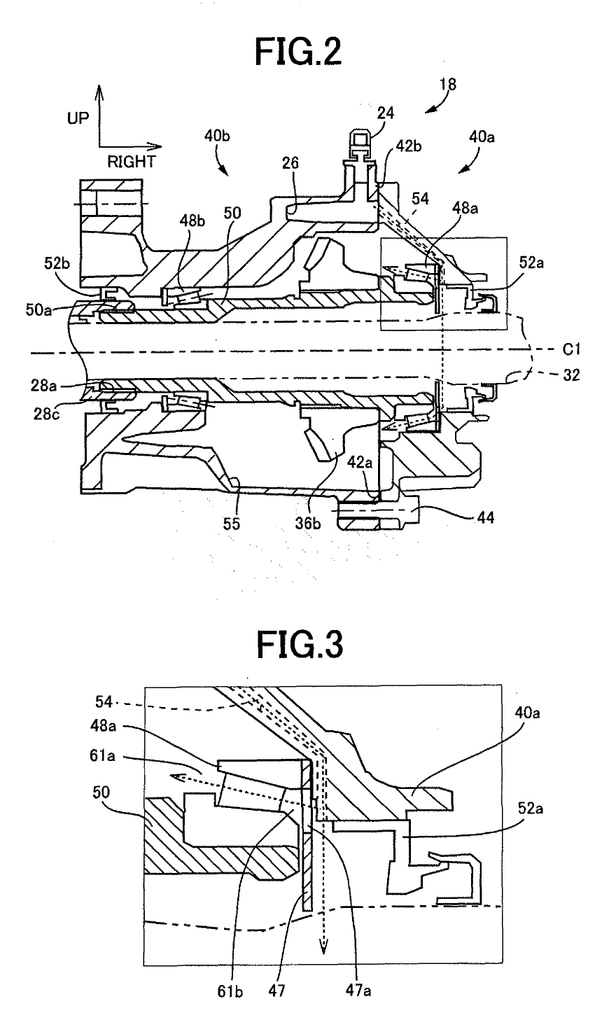

Reference is then made to the cross sectional view of FIG. 2 showing the transfer 18 as seen in the forward direction of the vehicle 10. This cross sectional view is taken in a vertical plane including a first axis C1, which is an axis of rotation of the front wheel axle 32 indicated by a one-dot chain line in FIG. 2. A housing in which the transfer 18 is accommodated consists of a transfer covering 40a and a transfer casing 40b, which are fixed together at respective interfacial surfaces 42a and 42b, with a plurality of screws 44. The sleeve 50 of the transfer 18 is supported by a first bearing 48a and a second bearing 48b, rotatably about the first axis C1. The first and second bearings 48a and 48b are tapered roller bearings. The ring gear 36b is rotated with the sleeve 50. The drive force of the engine 12 transmitted to the ring gear 36b through the inner gear teeth 28a of the casing 28c of the front wheel differential gear device 28 and the outer gear teeth 50a of the sleeve 50, which are splined to each other, is transmitted from the ring gear 36b to the rear wheels 16 through the propeller shaft 22. The front wheel axle 32 is disposed within the sleeve 50. In FIG. 2, two-dot chain lines indicate an outer circumferential surface of the front wheel axle 32.

The transfer 18 is provided with a breather device having a breather plug 24 of a known type, and a breather chamber 26. When the pressure of an air within the transfer 18 is raised, the air is ejected through the breather plug 24 into the outside atmosphere outside the transfer 18, so that leakage of a lubricant oil from the transfer 18 into the outside atmosphere is prevented or reduced. When the air pressure within the transfer 18 is lowered, on the other hand, the outside atmosphere (air) is sucked into the transfer 18 through the breather plug 24, while an entry of foreign matters into the transfer 18 is prevented by the breather plug 24, so that the air pressure within the transfer 18 is made equal or close to the pressure of the outside atmospheric. The inner space within the transfer 18 is defined by the transfer covering 40a, the transfer casing 40b, the sleeve 50, the breather plug 24, oil seals 52a and 52b, etc. The breather chamber 26 formed radially inwardly of the breather plug 24 has a function to store therein the lubricant oil introduced thereinto together with the air, while the air is ejected through the breather plug 24 into the outside atmosphere. The lubricant oil temporarily stored in the breather chamber 26 is returned into the inner space within the transfer 18, through an oil passage in the form of an oil relief hole 54. A dotted line in FIG. 2 indicates a path of flow of the lubricant oil from the breather chamber 26 into a central space 55 within the transfer 18, via the oil relief hole 54 and the first bearing 48a. The central space 55 (i.e., inner space) of the transfer 18 is oil-tightly sealed with the oil seals 52a and 52b.

The cross sectional view of FIG. 3 shows in enlargement a rectangular area indicated by a thin solid line in the cross sectional view of FIG. 2. In FIG. 3, the oil relief hole 54 formed within the transfer covering 40a is indicated broken lines, while the path of flow of the lubricant oil from the breather chamber 26 into the central space 55 through the oil relief hole 54 and the first bearing 48a is indicated by the dotted line as described above. Further, a path of radially inward flow of the lubricant oil to the transfer 18 induced by a rotary motion of a tapered roller 61 of the first bearing 48a is indicated by a radially inwardly extending arrow-headed dotted line. A spacer 47 in the form of a disc has a plurality of openings 47a and is fixedly sandwiched by and between the first bearing 48a and the transfer covering 40a. The openings 47a permit communication between the oil relief hole 54, and a small-diameter end side space 61b which is partly defined by a small-diameter end face of the tapered roller 61 of the first bearing 48a (tapered roller 61). Namely, the lubricant oil flows from the oil relief hole 54 into the small-diameter end side space 61b through the openings 47a of the spacer 47. The lubricant oil further flows from the small-diameter end side space 61b through the first bearing 48a into a large-diameter end side space 61a which is partly defined by a large-diameter end face of the tapered roller 61 of the first bearing 48a (tapered roller 61). The large-diameter end side space 61a is a part of the central space 55 within the transfer 18. It is noted that a space formed between the oil seal 52a and the spacer 47 is held in communication with the oil relief hole 54, so that the oil seal 52a is lubricated with the lubricant oil supplied from the oil relief hole 54.

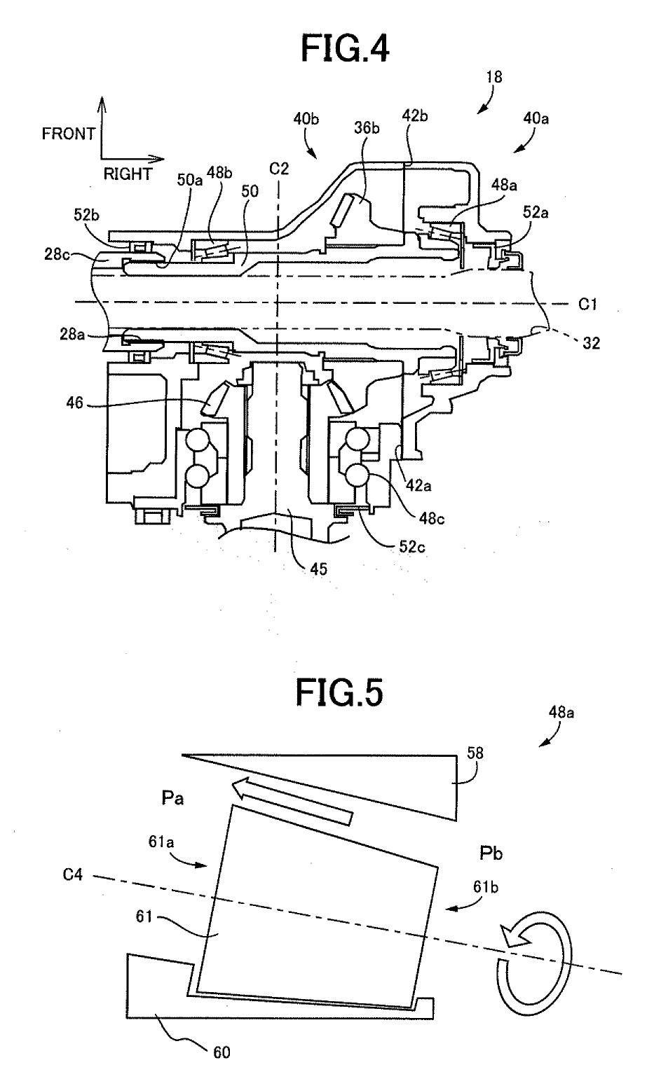

The cross sectional view of FIG. 4 is taken in a horizontal plane including the first axis C1, and a second axis C2 which is a common axis of rotation of the propeller shaft 22 and a rear wheel output shaft 45 connected to the propeller shaft 22. Namely, the plane of the cross sectional view of FIG. 4 is rotated by 90° about the first axis C1 with respect to that of the cross sectional view of FIG. 2. The driven pinion 46 splined to the rear wheel output shaft 45 is supported by a bearing 48c rotatably about the second axis C2. The driven pinion 46 is held in meshing engagement with the ring gear 36b, so that a rotary motion of the casing 28c of the front wheel differential gear device 28 is transmitted to the propeller shaft 22 through the driven pinion 46. The rear wheel output shaft 45 is provided with an oil seal 52c which also functions to oil-tightly seal the inner space within the transfer 18.

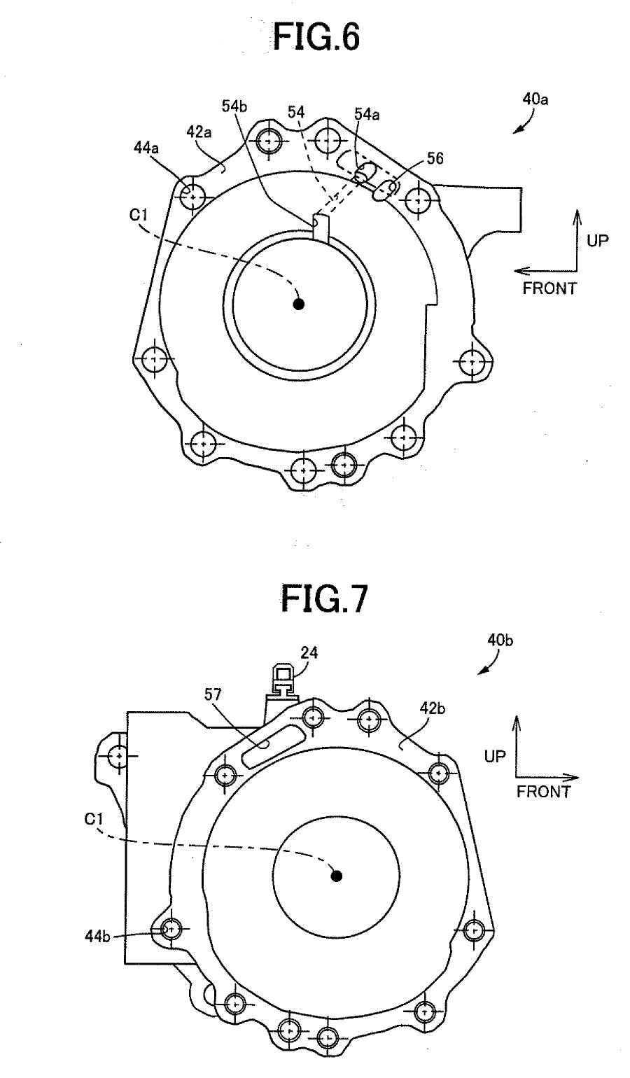

The schematic view of FIG. 5 schematically shows in enlargement the first bearing 48a which supports the sleeve 50 rotatably about the first axis C1. The first and second bearings 48a and 48b provided for rotatably supporting the sleeve 50 are tapered roller bearings, as described above. Each of these first and second tapered roller bearings 48a and 48b consists of the above indicated tapered roller 61, an outer race 58, and an inner race 60. The tapered roller 61 is rotatably held by and between the outer and inner races 58 and 60. When the tapered roller 61 is rotated about a fourth axis C4, there arises a difference between peripheral velocities of a large-diameter end portion and a small-diameter end portion of the tapered roller 61. This difference of the peripheral velocities generates a gradient of an air pressure such that the air pressure Pb is lower in the small-diameter end side space 61b than the air pressure Pa in the large-diameter end side space 61a. The oil relief hole 54 shown in FIG. 2 is held in communication with the small-diameter end side space 61b formed on the side of the small-diameter end of the first bearing 48a, while the large-diameter end side space 61a formed on the side of the large-diameter end of the tapered roller 61 of the first bearing 48a is held in communication with the breather chamber 26 through the inner space within the transfer 18, and through an air vent hole 56 shown in FIG. 6. When the above-indicated gradient of the air pressure is generated such that the air pressure Pb in the small-diameter end side space 61b is lower than the air pressure Pa in the large-diameter end side space 61a, the lubricant oil staying within the oil relief hole 54 is sucked and directed into the small-diameter end side space 61b on the side of the small-diameter end of the tapered roller 61 of the first bearing 48a, so that the lubricant oil staying within the breather chamber 26 is effectively discharged into the small-diameter end side space 61b through the oil relief hole 54. Further, the lubricant oil sucked into the small-diameter end side space 61b is returned through the first bearing 48a back into the inner space of the transfer 18. Thus, the lubricant oil flows in the direction indicated by the arrow headed dotted lines in FIG. 2, as a result of the rotary motion of the tapered roller 61 of the first tapered roller bearing 48a. This flow of the lubricant oil from the small-diameter end side space 61b toward the large-diameter end side space 61a is indicated by a thick arrow-headed line in FIG. 5.

FIG. 6 is the view showing the transfer covering 40a in an axial direction toward its interfacial surface 42a. As shown in FIG. 6, the first axis C1 extends through the center of the transfer covering 40a. Ten tapped holes 44a for the screws 44, and the air vent hole 56 for communication between the breather chamber 26 and the central space 55 are formed in the interfacial surface 42a, and an open end 54a (one of opposite open ends) of the oil relief hole 54 is open in the interfacial surface 42a. An area of the interfacial surface 42a which is enclosed by a two-dot chain line in FIG. 6 and in which the air vent hole 56 and the open end 54a of the oil relief hole 54 are included corresponds to a position of an opening 57 formed in an interfacial surface 42b of the transfer casing 40b shown in FIG. 7. The oil relief hole 54 has the other open end 54b formed in a radially inner portion of the transfer covering 40a, so that the breather chamber 26 is held in communication through this open end 54b with the small-diameter end side space 61b formed on the side of the small-diameter end of the tapered roller 61 of first bearing 48a, and the space formed between the spacer 47 and the oil seal 52a.

FIG. 7 is the view showing the transfer casing 40b in an axial direction toward its interfacial surface 42b. As shown in FIG. 7, the first axis C1 also extends through the center of the transfer casing 40b. Ten tapped holes 44b for the screws 44 are formed in the interfacial surface 42b, and the above-indicated opening 57 is open in the interfacial surface 42b. This opening 57 is held in communication with the breather chamber 26 formed radially inwardly of the breather plug 24, and is located in an area of the interfacial surface 42b corresponding to the above-indicated area of the interfacial surface 42a in which there are open the air vent hole 56 for equalizing the air pressures in the breather chamber 26 and the inner space within the transfer 18, and the open end 54a of the oil relief hole 54.

The vehicular power transmitting device in the form of the transfer 18 according to the present first embodiment is configured such that the power transmitting shaft in the form of the sleeve 50 accommodated within the housing in the form of the transfer covering 40a and the transfer casing 40b is rotated by the drive power source in the form of the engine 12, and rotatably supported by the housing through the first and second tapered roller bearings 48a, 48b and the breather chamber 26 of the breather device having the breather plug 24 provided on the transfer casing 40b is held in communication between the outside atmosphere outside the housing and the inside space within the housing through the breather plug 24. The transfer covering 40a has the oil passage in the form of the oil relief hole 54 for communication between the breather chamber 26 and the small-diameter end side space 61b which is partially defined by the small-diameter end face of the tapered roller 61 of the first tapered roller bearing 48a. When the tapered roller 61 of the first tapered roller bearing 48a is rotated during rotation of the sleeve 50, there arises a difference between the peripheral velocities of the large-diameter end portion and the small-diameter end portion of the tapered roller 61 of the first tapered roller bearing 48a, due to a difference between the outside diameters of the large-diameter and small-diameter end portions. This difference of the peripheral velocities generates a gradient of the air pressure such that the air pressure Pb is lower in the small-diameter end side space 61b than in the large-diameter end side space 61a, so that the lubricant oil is sucked and discharged through the oil relief hole 54 from the breather chamber 26 back into the housing in the form of the transfer covering 40a and the transfer casing 40b, whereby the leakage of the lubricant oil from the breather chamber 26 into the outside atmosphere can be effectively prevented or reduced.

The present embodiment is further configured such that the housing in the form of the transfer covering 40a and the transfer casing 40b is provided with the oil seal 52a located on the side of the small-diameter end of the tapered roller 61 of the first tapered roller bearing 48a, so that the lubricant oil can be effectively supplied to the oil seal 52a which is located at the position at which the oil seal 52a would be otherwise difficult to be sufficiently lubricated. Accordingly, the oil seal 52a can be lubricated with a high degree of efficiency, and deterioration of sealing property of the oil seal 52a can be effectively reduced.

In the present embodiment, the transfer covering 40a constituting a part of the housing of the vehicular power transmitting device in the form of the transfer 18 is formed with the oil relief hole 54 for communication between the breather chamber 26 and the small-diameter end side space 61b on the side of the small-diameter end of the tapered roller 61 of the first bearing 48a. The transfer casing 40b constituting the other part of the housing of the transfer 18 may be formed with an oil relief hole for communication between the breather chamber 26, and the small-diameter end side space formed on the side of the small-diameter end of the tapered roller 61 of the second bearing 48b, and a space formed adjacent to the oil seal 52b. This modification has substantially the same advantage as the first embodiment described above. Further, the housing may be formed with both of the oil relief hole 54 for communication of the breather chamber 26 with the small-diameter end side space 61b of the first bearing 48a and the space adjacent to the oil seal 52a, and the oil relief hole for communication between the breather chamber 26 and the small-diameter end side space on the side of the small-diameter end of the tapered roller 61 of the second bearing 48b and the space formed adjacent to the oil seal 52b. This modification also has substantially the same advantage as the first embodiment described above.

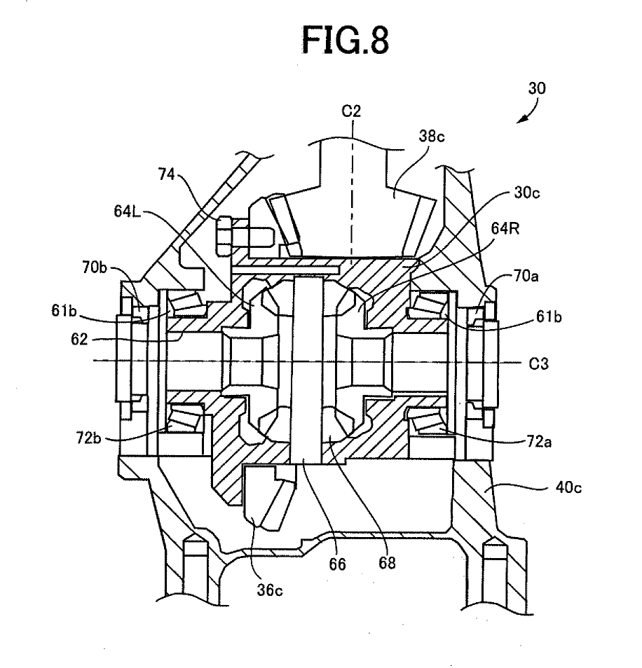

A second embodiment of this invention will be described by reference to the cross sectional view of FIG. 8. It is noted that the same reference signs as used in the first embodiment will be used in the second embodiment, to identify the corresponding elements, which will not be described redundantly. In the first embodiment, the power transmitting device in the form of the transfer 18 is constructed according to the principle of this invention. In the present second embodiment, however, the power transmitting device in the form of the rear wheel differential gear device 30 is constructed according to the principle of the present invention.

### Second Embodiment

The cross sectional view of FIG. 8 shows the rear wheel differential gear device 30 taken in a horizontal plane including a third axis C3, which is an axis of rotation of the rear wheel axle 34, and the second axis C2, which is the axis of rotation of the drive pinion 38c connected to the propeller shaft 22. The rear wheel differential gear device 30 is accommodated within a housing 40c, and oil-tightly sealed with oil seals 70a and 70b, and other oil seals not shown in FIG. 8. The ring gear 36c meshing with the drive pinion 38c is fixed to a casing 30c with screws 74. The casing 30c which serves as a power transmitting shaft is supported by bearings 72a and 72b rotatably about the third axis C3 (axis of rotation of the rear wheel axle 34). A rotary motion of the casing 30c causes a rotary motion of a pinion shaft 66. The pinion shaft 66 is provided with a pinion gear 68 fixed thereto for rotation therewith, and the pinion gear 68 is held in meshing engagement with side gears 64L and 64R rotated together with the respective rear wheel axles 34L and 34R. The casing 30c has an axle fitting hole 62 in which the left and right rear wheel axles 34L and 34R connected to the pinion gear 68 are fitted. As shown in FIG. 8, the bearing 72a is a tapered roller bearing, and an oil seal 70a is disposed adjacent to the bearing 72a. The housing 40c is provided with a breather device including a breather plug and a breather chamber which are respectively similar to the breather plug 24 and the breather chamber 26 in the first embodiment, for ejecting the air from the housing 40c into the outside atmosphere, as needed. Further, the housing 40c has an oil relief hole similar to the oil relief hole 54 provided in the first embodiment, which is provided for communication between the breather chamber, and a small-diameter end side space 61b partially defined by a small-diameter end face of a tapered roller 61 of the bearing 72a, and a space formed adjacent to the oil seal 70a. Accordingly, the present second embodiment has substantially the same advantage as the first embodiment.

The vehicular power transmitting device in the form of the rear wheel differential gear device 30 includes: the casing 30c; the housing 40c accommodating the casing 30c and rotatably supporting the casing 30c through the tapered roller bearings 72a and 72b; and the breather device provided in communication with the housing 40c and having the breather plug, and the breather chamber for communication through the breather plug between the inside space within the housing 40c and the outside atmosphere outside the housing 40c. The housing 40c has an oil passage in the form of the oil relief hole for communication between the breather chamber and the small-diameter end side space 61b which is partially defined by the small-diameter end face of the tapered roller 61 of the tapered roller bearing 72a. When the tapered roller 61 of the tapered roller bearing 72a is rotated, there arises a difference between the peripheral velocities of the large-diameter end portion and the small-diameter end portion of the tapered roller 61 of the tapered roller bearing 72a, due to a difference between the outside diameters of the large-diameter and small-diameter end portions. This difference of the peripheral velocities generates a gradient of the air pressure such that the air pressure Pb is lower in the small-diameter end side space 61b than the air pressure Pa in the large-diameter end side space 61a, so that the lubricant oil is sucked and discharged through the oil relief hole from the breather chamber back into the housing 40c, whereby the leakage of the lubricant oil from the breather chamber into the outside atmosphere can be effectively prevented or reduced.

The present second embodiment is further configured such that the housing 40c is provided with the oil seal 70a on the side of the small-diameter end side space 61b partially defined by the small-diameter end face of the tapered roller 61 of the tapered roller bearing 72a, so that the lubricant oil can be effectively supplied to the oil seal 70a which is located at the position at which the oil seal 70a would be otherwise difficult to be sufficiently lubricated. Accordingly, the oil seal 70a can be lubricated with a high degree of efficiency, and deterioration of sealing property of the oil seal 70a can be effectively reduced.

In the present second embodiment, the oil relief hole is formed for communication between the small-diameter end side space 61b on the side of the small-diameter end of the tapered roller 61 of the bearing 72a, and the breather chamber. However, the oil relief hole may be formed for communication between the breather chamber, and the small-diameter end side space 61b formed on the side of the small-diameter end of the tapered roller 61 of the bearing 72b. This modification has substantially the same advantage as the second embodiment described above, namely, permits effective prevention or reduction of leakage of the lubricant oil from the breather chamber, and effective prevention or reduction of deterioration of sealing property of the oil seal 70b.

Further, the housing 40c may be formed with both of the oil relief hole for communication of the breather chamber with the small-diameter end side space 61b on the side of the small-diameter end of the tapered roller 61 of the bearing 72a and the space adjacent to the oil seal 70a, and the oil relief hole for communication between the breather chamber and the small-diameter end side space 61b on the side of the small-diameter end of the tapered roller 61 of the bearing 72b and the space formed adjacent to the oil seal 70b. This modification also has substantially the same advantage as the second embodiment described above.

The transfer 18 according to the first embodiment, and the rear wheel differential gear device 30 according to the second embodiment are configured to prevent or reduce not only leakage of the lubricant oil from the housing, but also deterioration of the oil seals 52a, 52b, 70a, 70b. However, the principle of this invention is equally applicable to any other type of power transmitting device which is accommodated within an oil-tight housing and which includes a breather device having a breather plug and a breather chamber, as long as the housing of the power transmitting device is provided with a tapered roller bearing a tapered roller of which is rotated to return the lubricant oil from the breather chamber back into the inner space within the housing, as in the illustrated embodiments. Where the oil seal is located adjacent to a tapered roller bearing, the lubricant oil can be easily supplied to the oil seal, so that the oil seal can be lubricated with improved efficiency, and deterioration of sealing property of the oil seal can be effectively prevented or reduced. Both of the transfer 18 and the rear wheel differential gear device 30 which correspond to the embodiments of the present invention can be simultaneously employed.

While the preferred embodiments and modifications have been described for illustrative purpose only, it is to be understood that the present invention may be embodied with various changes and improvements, which may occur to those skilled in the art.

### NOMENCLATURE OF ELEMENTS

12: Engine (Drive power source)
18: Transfer (Vehicular power transmitting device)
24: Breather plug
26: Breather chamber
30: Rear wheel differential gear device (Vehicular power transmitting device)
30c: Casing (Power transmitting shaft)
40a: Transfer covering (Housing)
40b: Transfer casing (Housing)
40c: Housing
48a: First bearing (Tapered roller bearing)
48b: Second bearing (Tapered roller bearing)
50: Sleeve (Power transmitting shaft)
52a, 52b: Oil seals
54: Oil relief hole (Oil passage)
61b: Small-diameter end side space
70a, 70b: Oil seals
72a, 72b: Bearings (Tapered ball bearings)

What is claimed is:

1. A vehicular power transmitting device comprising: a power transmitting shaft rotated by a drive power source; a housing accommodating the power transmitting shaft and rotatably supporting the power transmitting shaft through a tapered roller bearing; and a breather device including a breather plug, and a breather chamber for communication between an outside atmosphere outside the housing and an inside space within the housing, through the breather plug, the vehicular power transmitting device being characterized in that:
the housing includes an oil passage for communication between the breather chamber and a small-diameter end side space partially defined by a small-diameter end face of a tapered roller of the tapered roller bearing.

2. The vehicular power transmitting device according to claim 1, wherein the housing is provided with an oil seal on the side of a small-diameter end of the tapered roller of the tapered roller bearing.

3. The vehicular power transmitting device according to claim 1, which is a transfer disposed between a front wheel differential gear device and a rear wheel differential gear device, and wherein the power transmitting shaft is operatively connected to the front wheel differential gear device and the transfer.

4. The vehicular power transmitting device according to claim 2, which is a transfer disposed between a front wheel differential gear device and a rear wheel differential gear device, and wherein the power transmitting shaft is operatively connected to the front wheel differential gear device and the transfer.

5. The vehicular power transmitting device according to claim 1, which is a rear wheel differential gear device operatively connected to a front rear wheel differential gear device through a transfer, and wherein the power transmitting shaft is a casing of the rear wheel differential gear device which is operatively connected to the front wheel differential gear device through a propeller shaft.

6. The vehicular power transmitting device according to claim 2, which is a rear wheel differential gear device operatively connected to a front rear wheel differential gear device through a transfer, and wherein the power transmitting shaft is a casing of the rear wheel differential gear device which is operatively connected to the front wheel differential gear device through a propeller shaft.
